(19) United States
(12) Patent Application Publication
(10) Pub. No.: US 2020/0332773 A1
(43) Pub. Date: Oct. 22, 2020

(54) A PROGNOSTICS AND HEALTH MANAGEMENT MODEL FOR PREDICTING WIND TURBINE OIL FILTER WEAR LEVEL

(71) Applicant: SIEMENS ENERGY, INC., Orlando, FL (US)

(72) Inventors: Guillaume Chabin, Princeton Junction, NJ (US); Amit Chakraborty, East Windsor, NJ (US); Akshay Patwal, Winter Springs, FL (US); Jennifer Zelmanski, Celebration, FL (US)

(21) Appl. No.: 15/999,285

(22) PCT Filed: Feb. 7, 2017
(86) PCT No.: PCT/US2017/016768

§ 371 Date: Aug. 17, 2018

Related U.S. Application Data
(60) Provisional application No. 62/296,165, filed on Feb. 17, 2016.

(51) Int. Cl. F03D 17/00; F03D 80/70; F01M 11/10; B01D 35/143

(52) U.S. Cl. CPC F03D 17/00; F03D 80/70; B01D 2201/54; B01D 35/143; F01M 11/10

(57) ABSTRACT

A method for predicting a wind turbine oil filter wear level wherein a differential pressure exists between upstream and downstream sides of the filter. The method includes extracting features from wind turbine sensor data to provide extracted data and selecting features from the extracted data that correlate with a change in the differential pressure. The method also includes estimating a filter condition by learning a filter regressive linear model that uses filter direct environment operating conditions data obtained from the extracted data. In addition, the method includes forecasting at least one operating condition scenario represented by three features obtained from the extracted data. Further, the method includes forecasting a filter wear level wherein the filter model uses the at least one forecasted operating condition scenario represented by the three features.

### CROSS REFERENCE TO RELATED APPLICATION

This application claims the benefit under 35 U.S.C. § 119(e) of copending U.S. Provisional Application No. 62/296,165 entitled CONDITION BASED MONITORING METHOD FOR WIND TURBINE LN-LINE GEAR OIL FILTERS USING LINEAR MODELS AND SEMI DETERMINISTIC FORECASTING METHODS, filed on Feb. 17, 2016, Attorney Docket No. 2016P03339US, which is incorporated herein by reference in its entirety and to which this application claims the benefit of priority.

### FIELD OF THE INVENTION

This invention relates to a model for predicting a wind turbine oil filter wear level, and more particularly, to a model that uses a prognostics and health management technique for predicting a wind turbine oil filter wear level wherein the technique uses linear regression models and semi deterministic forecasting methods on wind turbine sensor data.

### BACKGROUND OF THE INVENTION

Wind power has great potential to lessen our heavy dependence on fossil fuels. According to the U.S. Department of Energy, wind power has been one of the fastest growing sources of electricity production in the world in recent years. Wind power is generated by wind turbines that are arranged in a wind farm. Each wind turbine in the wind farm includes a plurality of sensors that monitor operation of the wind turbine. Readings from the sensors reflect the environment in which each wind turbine operates and provide snapshots of the condition or state of the wind turbine.

Wind turbines include advanced systems that require complex maintenance cycles. In particular, wind turbines include an in-line gear oil filter that cleans oil used to lubricate mechanical components and/or systems such as a wind turbine gearbox. It is desirable to monitor the condition of the in-line gear oil filter in order to avoid failure of the filter and possible damage to the wind turbine. In order to avoid such damage, the in-line gear oil filter is replaced before the filter becomes plugged or clogged. The filter is replaced on a calendar based maintenance strategy that coincides with the maintenance of other wear items in a wind turbine. For example, a filter may be changed every 12 months on average. However, this maintenance strategy results in filter changes that are performed without consideration of operational information. This leads to unnecessary filter changes since the filter is still usable, thus increasing maintenance costs.

### SUMMARY OF INVENTION

A method is disclosed for predicting a wind turbine oil filter wear level wherein a differential pressure exists between upstream and downstream sides of the filter. The method includes extracting features from wind turbine sensor data to provide extracted data and selecting features from the extracted data that correlate with a change in the differential pressure. The method also includes estimating a filter condition by learning a filter model that uses filter direct environment operating conditions data obtained from the extracted data on a linear regression model. In addition, the method includes forecasting at least one operating condition scenario represented by three features obtained from the extracted data. Further, the method includes forecasting a filter wear level wherein the filter linear model uses the at least one forecasted operating condition scenario represented by the three features.

In addition, a method is disclosed for detecting a wind turbine oil filter change wherein a differential pressure exists between upstream and downstream sides of the filter. The method includes extracting features from wind turbine sensor data to provide extracted data and selecting features from the extracted data that correlate with a substantial decrease in differential pressure. In addition, the method includes determining the differential pressure filter change points by using differential pressure local generative linear models having four coefficients. Further, the method includes detecting if the differential pressure substantially coincides with a substantial decrease in a coefficient.

Those skilled in the art may apply the respective features of the present invention jointly or severally in any combination or sub-combination.

### BRIEF DESCRIPTION OF DRAWINGS

The teachings of the present disclosure can be readily understood by considering the following detailed description in conjunction with the accompanying drawings, in which:

FIG. 1 is a flowchart for a forecasting method in accordance with the present invention.

FIGS. 2A and 2B depict, for a selected wind turbine, the correlation between αᵢ time series values and corresponding dPᵢ values, respectively.

FIG. 3 depicts an environment for a wind turbine in-line filter.

FIG. 4 depicts a flowchart for operating condition forecasting and filter wear level forecasting.

FIG. 5 is a graphical representation of a dP forecast made 52 weeks in advance.

FIG. 6 is a block diagram of a computer system in which embodiments of the present invention may be implemented.

FIG. 7 is a block diagram of an exemplary lubrication system for a wind turbine.

To facilitate understanding, identical reference numerals have been used, where possible, to designate identical elements that are common to the figures.

### DETAILED DESCRIPTION

Although various embodiments that incorporate the teachings of the present disclosure have been shown and described in detail herein, those skilled in the art can readily devise many other varied embodiments that still incorporate these teachings. The scope of the disclosure is not limited in its application to the exemplary embodiment details of construction and the arrangement of components set forth in the description or illustrated in the drawings. The disclosure encompasses other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

Embodiments of the present invention described herein are applicable to mechanical or electromechanical devices or systems, such as wind turbines, that utilize a plurality of sensors that detect a property or operation of the device or system. In particular, the present invention will be described in connection with wind turbines that include advanced systems that require complex maintenance cycles. Wind turbines include an in-line gear oil filter that cleans oil used to lubricate mechanical components and/or systems such as a wind turbine gearbox. It is desirable to monitor the condition of the filter in order to avoid failure of the filter and possible damage to the wind turbine. More than one type of failure mode exists for an-line gear oil filter. It has been determined that a failure mode wherein the filter becomes plugged or clogged is of particular interest since this failure mode is the most realistic failure scenario that occurs when the wind turbine is subjected to standard operating conditions. Further, filter clogging appears to be an early stage of many other failure types.

### Model

In accordance with aspects of the present invention, a forecasting model for differential pressure (i.e. a filter wear proxy) is developed incrementally. A calendar based strategy that includes scheduled service dates is typically used for the maintenance of wind turbines. The present invention enables determination of whether an in-line gear oil filter should be changed at a next scheduled service date or whether changing of the filter may be delayed until a subsequent scheduled service date, for example. The mathematical formulation is as follows:

For a given turbine and a given day t, define model fₜ as:

dP_{t+h|t} [symbol] InlPrBef_{t+h|t}−InlPrAft_{t+h|t}=fₜ(xᵢ, . . . ,xₜ), ∀h∈

[symbol]

where

### h: Time Horizon

xₜ: Sensor readings at time t (i.e. InlPrBefₜ, InlPrAftₜ, GenRpinₜ,GeOilTmpₜ, . . . )
InlPrBefₜ: Upstream pressure at time t
InlPrAftₜ: Downstream pressure at time t
In order to solve the forecasting problem at given t, a good approximation of fₜ is learned using the following sub problems:

### Features Extraction and Features Selection:

(x)_{1, . . . ,t}→(InlPrBef,InlPrAft,z)_{1, . . . ,t}

where zᵢ=(filterIdᵢ,ageᵢ,GenRpmᵢ,GeOilTmpᵢ)

### Inline Filter Condition Estimation:

For the current filter data learn the linear regression model Mₜ such as

dPᵢ≈Mₜ(zᵢ), ∀i≤t, filterIdᵢ=filterIdₜ

### Operating Conditions Forecasting:

Forecast z_{t+h|t} with confidence interval: \hat{z}_{t+h|t}=H(z₁, . . . , zₜ)

Forecasting of a wear level of the filter is then obtained by combining the operating conditions forecast with a learned filter model Mₜ according to [symbol] _{t+h|t}=Mₜ(\hat{z}_{t+h|t). Thus, a prediction of dP}_{t+h|t} may be calculated for a given tuple (turbine, horizon, time) based on historical SCADA data of a given wind turbine as will be described.

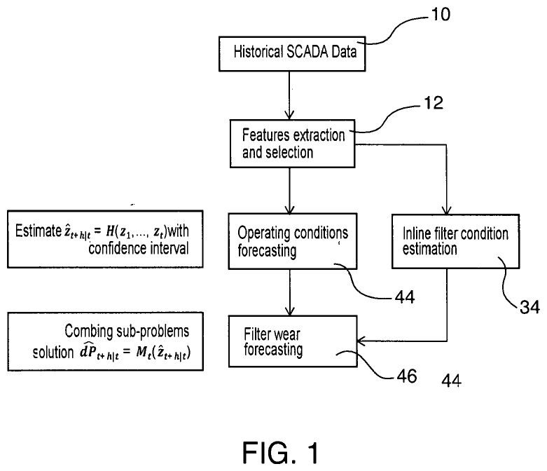

Referring to FIG. 1, a flowchart for a forecasting method in accordance with the present invention is shown. Wind turbines utilize a known Supervisory Control and Data Acquisition (SCADA) control system that uses sensors to detect various wind turbine properties or features. This includes features such as an in-line pressure before and after the filter (i.e. Upstream pressure InlPrBefₜ and Downstream pressure InlPrAftₜ,respectively), turbine generator revolutions per minute (i.e. GenRpm), gear oil temperature (i.e. GeOilTmp) and other properties over a period of time to generate historical SCADA data at Step 10.

The SCADA data may be used to calculate wind turbine parameters. It has been determined that a difference between the upstream and downstream pressures of the filter (i.e. differential pressure dP_{t+h|t} [symbol] InlPrBef_{t+h|t}−InlPrAft_{t+h|t}) indicates a level or degree of plugging of the filter and the remaining lifetime of the filter. In particular, dP increases as filter plugging or clogging increases. Thus, dP is an indicator or proxy for filter wear. Accordingly, dP is calculated from the sensor readings available from the SCADA data corresponding to the filter upstream and downstream pressures.

### Features Extraction

At step 12, features are extracted and selected from the historical SCADA data as will be described. An in-line filter is replaced during operation of the wind turbine. It has been determined that replacement of a clogged or plugged filter with a new filter causes a substantial decrease in dP. An aspect of the present invention includes determining whether a substantial decrease in dP has occurred, based on the SCADA data, to thus indicate that a corresponding filter change has occurred. Further, the substantial decrease in dP must not coincide with a change in a defined set of operating conditions, as will be described, in order to indicate that a filter change has occurred.

The dP is modeled as a linear combination of a time index, GeOilTmp and GenRpm for a predetermined time period (for example, 30 days) by dP˜α time+β GeOilTmp+γ GenRpm+η under the following restricted operating conditions (i.e. OC1): data having known sensor errors is omitted, GenRpm must be greater than 1000 rpm, GeOilTmp must be between 35-45 degrees C. and a turbine pump of the wind turbine must be in high speed mode.

Thus, if a substantial decrease in dP has occurred and the GeOilTmp exceeds 45 degrees C., for example, the decrease in dP is not indicative of a filter change. The coefficient αᵢ, learned on day i, can be interpreted as the contribution of time on dP during the previous 30 days. For example, if α=0.1 and the operating conditions for GenRpm and GeOilTmp remain constant, dP will increase by 0.1 bar in 30 days.

In particular, a filter change is detected at a time t if the time contribution on dP in the previous 30 days significantly decreases (i.e. αₜ starts to drop −4σ away from the average a on the wind turbine observed so far). Due to the characteristics of the linear model, it has been determined that there is a delay for the index i for which αᵢ<α̅−4σ with respect to an actual filter change. In accordance with the present invention, two thresholds are thus introduced: α₁=α̅−σ and α₂=α̅−4σ. A filter change is then indicated at the start of a substantial dP decrease (i.e. αₜ≠α₁ and αₜ≈α₂ shortly after).

### Formal Definition:

Let (αₜ,βₜ,γₜ,ηₜ) be the coefficients of the linear model learned on the day t using the previous 30 days SCADA data filtered under operating conditions OC1. Then,

dP≠αtime+βGeOilTmp+γGenRpm+η.

Let α̅ₜ and σₜ be the mean and standard deviation, respectively, of {αᵢ}_{i≤t}.
It has been determined that a filter change is detected at time T if and only if:

$$∃ h \geq 0 , \{ \begin{matrix}∀ ɛ ∈ [ 0 ; h ] , {α}_{t + ɛ} \leq \overline{{α}_{T + h}} - {σ}_{T + h} \\ {α}_{T - 1} > \overline{{α}_{T + h}} - {σ}_{T + h} \\ {α}_{T + h} \leq \overline{{α}_{T + h}} - 4 {σ}_{T + h}\end{matrix}$$

For example, the definition indicates that a filter is triggered at a time T₁ if and only if, an integer h₁ exists such that:
dP_{T}_{₁}₋₁ is greater than α̅_̅{̅T̅}̅_̅{̅₁̅}̅₊̅ₕ̅_̅{̅₁̅}̅−σ_{T}_{₁}₊ₕ_{₁}
dP_{T}_{₁}₊ₕ_{₁} is less than or equal to α̅_̅{̅T̅}̅_̅{̅₁̅}̅₊̅ₕ̅_̅{̅₁̅}̅−4σ_{T}_{₁}₊ₕ_{₁}
dP is below α̅_̅{̅T̅}̅_̅{̅₁̅}̅₊̅ₕ̅_̅{̅₁̅}̅−σ_{T}_{₁}₊ₕ_{₁} between the time T₁ and T₁+h₁

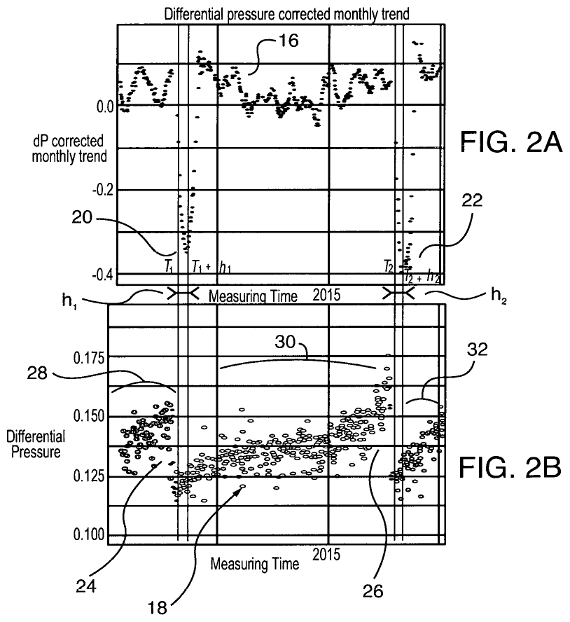

FIGS. 2A and 2B depict, for a selected wind turbine, the correlation between αᵢ time series values 16 (learned every day from the previous 30 days) and corresponding dPᵢ values 18, respectively. In particular, FIGS. 2A and 2B show that a substantial decrease in αᵢ time series values 16 in regions 20, 22 corresponds with a substantial decrease in dPᵢ values 18 in regions 24, 26, respectively. In order to ensure that a substantial decrease in dP value is indicative of a filter change, a corresponding substantial decrease in a value must occur within buffers h₁ and h₂ (see FIGS. 2A and 2B). When this occurs, it is determined that a filter change occurred at time T₁ and time T₂. Thus, data in regions 28, 30 and 32 of FIG. 2B correspond to first, second and third filters, respectively (i.e. different filters). In accordance with the present invention, the time at which filter changes occurred is determined from the SCADA data. This enables determination of a change date for a filter and the age of the filter in seconds, for example. Each filter used in the wind turbine is identified by a filter identification (i.e. filterId). Further, the SCADA data may be augmented with the filter age at each timestamp.

A plurality of features are extracted from the SCADA data and used to generate a dataset. The dataset is scrubbed or cleaned using the following criteria: data having known sensor errors is omitted, only data obtained when a turbine pump of the wind turbine is in high speed mode is used, daily averages for dP are calculated and wind turbine features (i.e. z) are selected based on a correlation study to determine features that substantially affect dP (i.e. features that are highly correlated with dP) and consensus knowledge of wind turbine experts. The correlation study is conducted with respect to a plurality of extracted wind turbine features such as gear pump state, oil cooler state, flow rate, turbine generator revolutions per minute (i.e. GenRpm), gear oil temperature (i.e. GeOilTmp), filter age and other features. Based on the correlation study, the features z selected are GenRpm, GeOilTmp and filter age. The correlation study may be conducted more than once.

### Inline Filter Condition Estimation

Referring back to FIG. 1, an in-line filter condition is estimated at Step 34. Inline filter condition estimation serves as a first sub-problem. Once the features are selected as previously described in Step 12, the current filter condition can be estimated by fitting a linear model with the cleaned historical data. In a particular, an analysis is performed wherein:

dPᵢ≈Mₜ(zᵢ), ∀i≤t, filterIdᵢ=filterIdₜ

wherein Mₜ is a regression model. Based on the consensus knowledge of wind turbine experts and data mining, Mₜ is assumed to be linear and learned using cleaned daily historical data {zᵢ, ∀i≤t, filterIdᵢ=filterIdₜ} with a regularized linear model such as a known ridge regression. With respect to ridge regression analysis, the disclosure of RIDGE REGRESSION: APPLICATIONS TO NONORTHOGONAL PROBLEMS by Arthur E. Hoerl and Robert W. Kennard, published in Technometrics, Vol. 12, No. 1. (February, 1970), pp. 69-82 is incorporated by reference in its entirety.

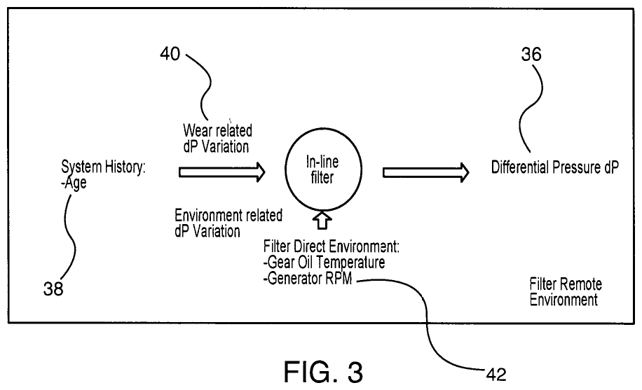

Referring to FIG. 3, an environment for a wind turbine in-line filter is shown as a schematic. With respect to Mₜ, the filter condition (at the time t) is modeled as a input/output function mapping any operating condition z to a differential pressure. Thus, the regression model distinguishes the contribution to dP 36 due to filter age 38 (i.e. wear related dP variation 40) from the dP variation induced by a change of the direct filter environment (GeOilTmp, GenRpm) 42. In addition, a confidence interval on coefficients of the model Mₜ is generated using known bootstrapping techniques.

### Operation Condition Forecasting

Referring back to FIG. 1, operations condition forecasting is then performed at Step 44. In an embodiment, Step 44 is performed at the same time as Step 34. Operation condition forecasting serves as a second sub-problem. In step 44, the operating conditions in which the filter should run at a time t+h from the past values (i.e. \hat{z}_{t+h|t}=H(z₁, . . . , zₜ)) are forecast or estimated with a confidence interval by using known methods. For example, if the current age of a filter is known it may be desirable to forecast the age of the filter in t+h days.

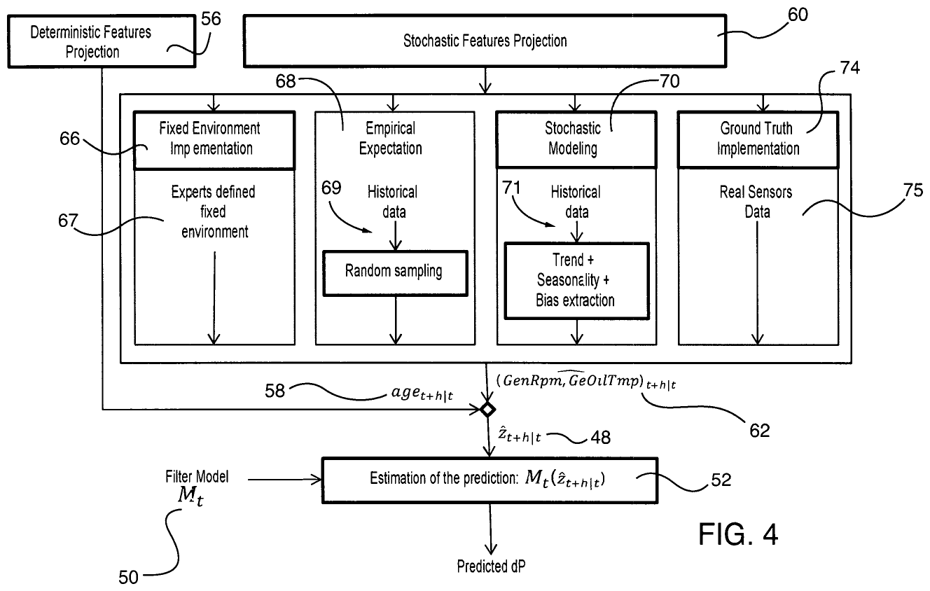

In particular, z is composed of a deterministic component that can be predicted exactly (for example, the age of the filter) and a stochastic component that can only be estimated with some uncertainty as will be described in relation to FIG. 4.

### Filter Wear Level Forecasting

Referring to FIG. 1, wear level forecasting is performed at Step 46. Wear level prediction is calculated by combining the first and second sub-problems to form a solution wherein:

[symbol]

_{t+h|t}=Mₜ(\hat{z}_{t+h|t}).

In addition, a global confidence interval is calculated by aggregating the confidence interval from \hat{z}_{t+h|t} and Mₜ. In particular, the filter linear model Mₜ described in connection with Step 34 provides a function. Then, the operating condition from Step 44 is used in Mₜ to provide an estimate of the differential pressure (i.e. [symbol] _{t+h|t}) which in turn is indicative of a filter wear level.

Referring to FIG. 4, a flowchart for operating condition forecasting and filter wear level forecasting is shown. In accordance with the present invention, projections for both deterministic features and stochastic features are used to determine \hat{z}_{t+h|t} 48 used in calculating filter regression model Mₜ 50, an estimation of the prediction Mₜ(\hat{z}_{t+h|t}) 52 and ultimately a predicted dP 54 At Step 56, a projection is made for a deterministic feature. For example, if the deterministic feature is filter age and the current age of the filter is known, the age of the filter in t+h days can be determined in accordance with age_{t+h|t} 58.

At Step 60, a projection is made with respect to stochastic features in accordance with (GenRp [symbol] OilTmp)_{t+h|t} 62. A method for projecting stochastic features includes performing a fixed environment implementation at Step 66. In this step, stochastic variables are fixed in advance by wind turbine experts 67 to enable investigation of a selected scenario for the wind turbine. For example, it may be desirable to investigate a scenario wherein the wind turbine gear oil temperature (i.e. GeOilTmp) is fixed at 40 degrees C. and the turbine generator rotational speed (i.e. GenRpm) is fixed at 1000 RPM. Another method includes performing an experimental expectation calculation at Step 68. In this step, a random sampling of historical data 69 is performed in order to generate a distribution of operating conditions and calculate their probability. The calculated probability is then used in estimating \hat{z}_{t+h|t} 48. In addition, stochastic modeling may be used at Step 70. In this step, GeOilTmp and GenRpm are treated as a multivariate time series which is decomposed into a trend, a seasonal term, a bias term and a purely stochastic term of zero mean 71. In particular, stochastic variables are modeled from the historical data in accordance with a known technique. Since the environment is also evolving, a generative model is learned from the historical data that forms a basis for environment estimation. Further, ground truth implementation method may be used at Step 74. In this step, ground source data such as real or actual sensor data 75 is used as input for a model Mₜ 50. The results from this model are then compared to a prediction previously made by the same model Mₜ in order to assess the accuracy of the model Mₜ.

The present invention uses machine learning and data analytics to incrementally learn a wind turbine-based model of an in-line filter wear. For each wind turbine, a tuned (adapted to the specific turbine) predictive model is learned based on historical SCADA data of the associated wind turbine. The present invention also identifies and discriminates the impact of environmental operating conditions on a filter wear proxy. In addition, the present invention provides estimates of the wear level on a long horizon and provides confidence intervals.

Further, the present invention provides a data-driven model that optimizes filter exchange intervals for each wind turbine unit. The present invention uses linear models and historical sensor readings to learn the impact on a filter of both direct environment and filter history. Given the current condition of a filter, the present invention enables simulation of filter wear on a long time horizon and for different operating environments. Based on these simulations, a maintenance/service team can choose to postpone the filter change to the posterior planned visit. Thus, filter life is extended while ensuring that an additional site visit is not introduced. Further, the present invention is compatible with the current calendar based strategy for the maintenance of wind turbines.

The present invention only requires currently available and basic SCADA data to forecast a filter wear level on a long time horizon. In particular, all information is obtained from currently available sensor readings from the SCADA system such as the in-line Upstream pressure InlPrBefₜ and in-line Downstream pressure InlPrAftₜ, turbine generator revolutions per minute (i.e. GenRpm) and gear oil temperature (i.e. GeOilTmp). In addition, the present invention is compatible with pre-existing wind turbine units and can be readily integrated in existing SCADA based continuous monitoring systems. Further, the present invention avoids the use of data available from enterprise resource planning systems (ERP) which are not compatible with each other.

### Test Results

Aspects of the present invention were integrated into an existing wind turbine continuous monitoring system. As part of the test, the previous two years of historical SCADA data for a wind turbine were used. The output is a prediction of the filter wear level (i.e. the differential pressure dP) for four different forecasting horizons along with a confidence interval.

TABLE 1

| StationId | InsertTime | TargetTime | LBound | UBound | Model |
|---|---|---|---|---|---|
| 123 | 2016 Dec. 18 23:59:59 | 2017 Jan. 01 00:00:00 | 0.5926 | 0.8437 | 0.7173 |
| 123 | 2016 Dec. 18 23:59:59 | 2017 Mar. 19 00:00:00 | 0.6546 | 0.9059 | 0.7794 |
| 123 | 2016 Dec. 18 23:59:59 | 2017 Jun. 18 00:00:00 | 0.7278 | 0.9794 | 0.8528 |
| 123 | 2016 Dec. 18 23:59:59 | 2017 Dec. 17 00:00:00 | 0.8743 | 1.1268 | 0.9995 |

TABLE 1
Key

| | |
|---|---|
| StationId: | Identification of the wind turbine |
| InsertTime: | Date on which the prediction is made |
| TargetTime: | Date for which the prediction is valid |
| LBound: | Lower Bond of the prediction |
| UBound: | Upper Bond of the prediction |
| Model: | Average of the prediction |

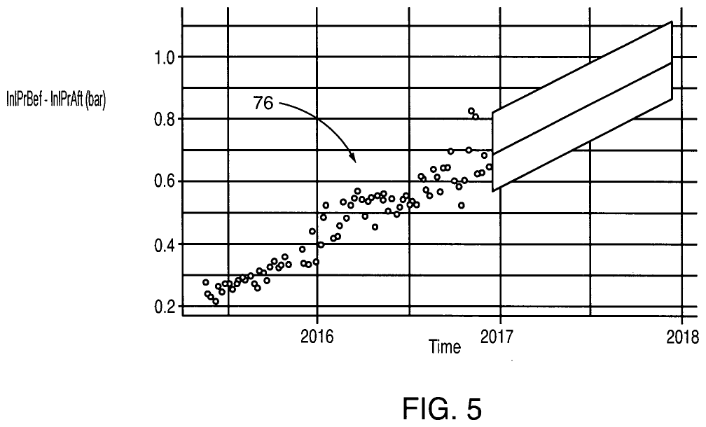

FIG. 5 depicts the distribution of dP (i.e. InlPrBef−InlPrAft) data points 76 with respect to time for a dP forecast made 52 weeks in advance. In particular, the confidence interval for this forecast is calculated as 96%.

It is to be understood that exemplary embodiments of the present disclosure may be implemented in various forms of hardware, software, firmware, special purpose processors, or a combination thereof. In one embodiment, a method for energy management control may be implemented in software as an application program tangibly embodied on a computer readable storage medium or computer program product. As such, the application program is embodied on a non-transitory tangible media. The application program may be uploaded to, and executed by, a processor comprising any suitable architecture.

It should further be understood that any of the methods described herein can include an additional step of providing a system comprising distinct software modules embodied on a computer readable storage medium. The method steps can then be carried out using the distinct software modules and/or sub-modules of the system, as described above, executing on one or more hardware processors. Further, a computer program product can include a computer readable storage medium with code adapted to be implemented to carry out one or more method steps described herein, including the provision of the system with the distinct software modules.

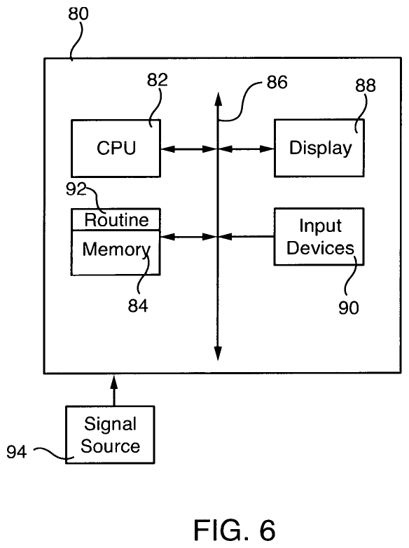

FIG. 6 is a block diagram of a computer system 80 in which embodiments of the above described methods may be implemented. The computer system 80 can comprise, inter alia, a central processing unit (CPU) 82, a memory 84 and an input/output (I/O) interface 86. The computer system 80 is generally coupled through the I/O interface 86 to a display 88 and various input devices 90 such as a mouse, keyboard, touchscreen, camera and others. The support circuits can include circuits such as cache, power supplies, clock circuits, and a communications bus. The memory 84 can include random access memory (RAM), read only memory (ROM), disk drive, tape drive, storage device etc., or a combination thereof. The present invention can be implemented as a routine 92 that is stored in memory 84 and executed by the CPU 82 to process a signal from a signal source 94. As such, the computer system 80 is a general-purpose computer system that becomes a specific purpose computer system when executing the routine 92 of the present invention. The computer system 80 can communicate with one or more networks such as a local area network (LAN), a general wide area network (WAN), and/or a public network (e.g., the Internet) via a network adapter. In addition the computer system 80 may be used as a server as part of a cloud computing system where tasks are performed by remote processing devices that are linked through a communications network. In a distributed cloud computing environment, program modules may be located in both local and remote computer system storage media including memory storage devices.

The computer platform 80 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device. Examples of well-known computing systems, environments, and/or configurations that may be suitable for use with computer system 80 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices and the like.

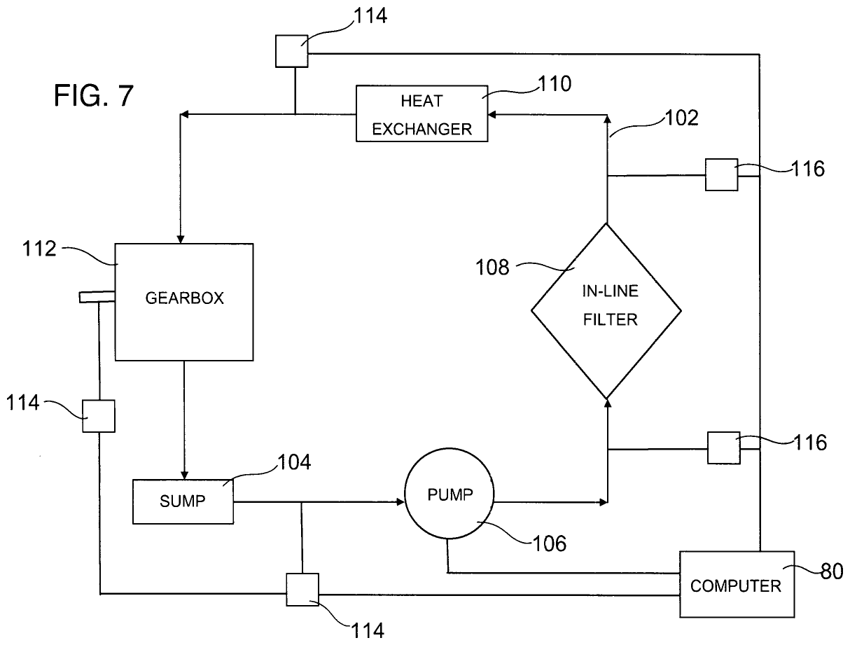

Referring to FIG. 7, a block diagram of an exemplary lubrication system 100 for a wind turbine is shown. The system 100 includes a lubrication circuit 102 having a sump 104 (i.e. a reservoir of lubricant such as oil), an in-line pump 106 for circulating the lubricant, an in-line filter 108 for filtering the lubricant and a heat exchanger 110 arranged in series. In operation, lubricant from the sump 104 is circulated through the in-line filter 108 by the pump 106. Filtered lubricant from the inline filter 108 is then passed through the heat exchanger 110 which serves to cool the lubricant before the lubricant is delivered to a gearbox. The inline pump 106 is controlled by the computer system 80 to circulate lubricant through the lubrication circuit 102 at a selected flow rate.

A plurality of sensors 114 are used to provide sensor readings for monitoring operation of the lubrication circuit 102. For example, this includes sensor readings for a gear pump state, oil cooler state, flow rate, turbine generator revolutions per minute (i.e. GenRpm), gear oil temperature (i.e. GeOilTmp), and an in-line pressure before and after the filter (i.e. Upstream pressure InlPrBefₜ and Downstream pressure InlPrAftₜ,respectively). It is desirable to monitor the condition of the in-line filter 108 so that the filter 108 is replaced before it becomes plugged or clogged. As previously described, a difference between the upstream and downstream pressures of the filter 108 (i.e. dP) indicates a level or degree of plugging of the filter 108 and the remaining lifetime of the filter 108. In particular, dP increases as filter plugging or clogging increases. Accordingly, dP is calculated from the sensor readings available from sensors 116 corresponding to the filter upstream and downstream pressures. The sensor readings from the sensors 114, 116 are provided to the computer 80 for enabling calculations in accordance with the present invention.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A method for predicting a wind turbine oil filter wear level, wherein a differential pressure exists between upstream and downstream sides of the filter, comprising:
extracting features from wind turbine sensor data to provide extracted data;
selecting features from the extracted data that correlate with a change in the differential pressure;
estimating a filter condition by learning a filter regressive linear model that uses filter direct environment operating conditions data obtained from the extracted data;
forecasting at least one operating condition scenario represented by three features obtained from the extracted data; and
forecasting a filter wear level wherein the filter regressive linear model uses the at least one forecasted operating condition scenario represented by the three features.

2. The method according to claim 1, wherein the change in differential pressure includes a substantial decrease in differential pressure indicative of a filter change.

3. The method according to claim 2, further including determining a filter age upon detection of a substantial decrease in differential pressure.

4. The method according to claim 2, further including determining a filter change date upon detection of a substantial decrease in differential pressure.

5. The method according to claim 2, wherein the differential pressure is determined by using a differential pressure generative linear model having four coefficients.

6. The method according to claim 5, wherein the substantial decrease in differential pressure substantially coincides with a substantial decrease in a coefficient.

7. The method according to claim 1, wherein the filter direct environment operating conditions data includes gear oil temperature data.

8. The method according to claim 1, wherein the filter direct environment operating conditions data includes generator revolutions per minute data.

9. The method according to claim 1, wherein the sensor data is obtained from a Supervisory Control and Data Acquisition (SCADA) control system for the wind turbine.

10. A method for detecting a wind turbine oil filter change, wherein a differential pressure exists between upstream and downstream sides of the filter, comprising:
extracting features from wind turbine sensor data to provide extracted data;
selecting features from the extracted data that correlate with a substantial decrease in differential pressure;
determining the differential pressure by using a differential pressure model having four coefficients; and
detecting if the differential pressure substantially coincides with a substantial decrease in a coefficient.

11. The method according to claim 10, wherein the differential pressure substantially coincides with a substantial decrease in a coefficient if at time T
$$∃ h \geq 0 , \{ \begin{matrix}∀ ɛ ∈ [ 0 ; h ] , {α}_{t + ɛ} \leq \overline{{α}_{T + h}} - {σ}_{T + h} \\ {α}_{T - 1} > \overline{{α}_{T + h}} - {σ}_{T + h} \\ {α}_{T + h} \leq \overline{{α}_{T + h}} - 4 {σ}_{T + h}\end{matrix}$$
wherein α̅ₜ and αₜ are the mean and standard deviation, respectively, of {αᵢ}_{i≤t}, h is a time horizon and α is the coefficient.

12. The method according to claim 10, further including determining a filter age upon detection of a substantial decrease in differential pressure.

13. The method according to claim 10, further including determining a filter change date upon detection of a substantial decrease in differential pressure.

14. A method for predicting a wind turbine oil filter wear level, wherein a differential pressure exists between upstream and downstream sides of the filter, comprising:
extracting features from wind turbine sensor data to provide extracted data;
selecting features from the extracted data that correlate with a substantial decrease in differential pressure indicative of a filter change;
estimating a filter condition by learning a filter regressive linear model that uses filter direct environment operating conditions data obtained from the extracted data;
forecasting at least one operating condition scenario represented by three features obtained from the extracted data; and
forecasting a filter wear level wherein the filter regressive linear model uses the at least one forecasted operating condition scenario represented by the three features having deterministic and stochastic components.

15. The method according to claim 14, wherein the stochastic component includes either a fixed environment implementation, an experimental expectation calculation, stochastic modeling or ground truth implementation.

16. The method according to claim 14, further including determining a filter age upon detection of a substantial decrease in differential pressure.

17. The method according to claim 14, further including determining a filter change date upon detection of a substantial decrease in differential pressure.

18. The method according to claim 14, wherein the differential pressure is determined by using a differential pressure linear model having four coefficients.

19. The method according to claim 18, wherein the substantial decrease in differential pressure substantially coincides with a substantial decrease in a coefficient.

20. The method according to claim 14, wherein the sensor data is obtained from a Supervisory Control and Data Acquisition (SCADA) control system for the wind turbine.
